(19) United States
(12) Patent Application Publication
(10) Pub. No.: US 2025/0301109 A1
(43) Pub. Date: Sep. 25, 2025

(54) PROJECTION METHOD

(71) Applicant: SEIKO EPSON CORPORATION, Tokyo (JP)

(72) Inventor: Kohei YANAI, MATSUMOTO-SHI (JP)

(21) Appl. No.: 19/082,708

(22) Filed: Mar. 18, 2025

(30) Foreign Application Priority Data
Mar. 25, 2024 (JP) 2024-047706

(51) Int. Cl. H04N 9/31

(52) U.S. Cl. CPC H04N 9/3194; H04N 9/3182

(57) ABSTRACT

A projection method includes projecting a first reference image onto a projection target, acquiring a first captured image by capturing the first reference image by a capturing device having a capturing element, projecting a second reference image onto the projection target, acquiring a second captured image by capturing the second reference image by the capturing device, determining a type of a structured light to be projected from a projection device based on a differential image between the first captured image and the second captured image, a pixel number of a light modulation element, and a pixel number of the capturing element by a processing device, and projecting the structured light from the projection device according to a result of the determination of the type of the structured light.

The present application is based on, and claims priority from JP Application Serial Number 2024-047706, filed Mar. 25, 2024, the disclosure of which is hereby incorporated by reference herein in its entirety.

### BACKGROUND

### 1. Technical Field

The present disclosure relates to a projection method.

### 2. Related Art

JP-A-2022-174999 discloses a technique of specifying a correspondence relationship between a plurality of pixels of an image projected from a projection device and a plurality of pixels of a captured image captured by a capturing device using a gray code image as an example of a structured light.

JP-A-2022-174999 is an example of the related art.

The type of the structured light is preferably selected according to the nature of a display surface, an installation environment of the projection device, or the like. However, it may be impossible to change the type of the structured light using the technique disclosed in JP-A-2022-174999. Further, it is difficult for a user to determine in which case which type of the structured light to select.

### SUMMARY

A projection method according to an aspect of the present disclosure is a projection method in a projection device including a light modulation element modulating a light from a light source, including projecting a first reference image including a first portion having a first pixel number onto a projection target, acquiring a first captured image by capturing the first reference image by a capturing device having a capturing element, projecting a second reference image onto the projection target, acquiring a second captured image by capturing the second reference image by the capturing device, determining a type of a structured light to be projected from the projection device based on a differential image between the first captured image and the second captured image, the first pixel number, and a second pixel number as a pixel number of a second portion corresponding to the first portion in the first captured image by a processing device, and projecting the structured light from the projection device according to a result of the determination of the type of the structured light.

A projection method according to another aspect of the present disclosure is a projection method in a projection device including a light modulation element modulating a light from a light source, including displaying an interface image for receiving input of information on a projection condition, determining a type of a structured light to be projected from the projection device based on a projection condition input using the interface image by a processing device, and projecting the structured light from the projection device according to a result of the determination of the type.

### BRIEF DESCRIPTION OF THE DRAWINGS

FIG. 1 shows an overview of a system used for a projection method according to a first embodiment.

FIG. 2 is a block diagram of a projection device used for the projection method according to the first embodiment.

FIG. 3 is a flowchart showing a flow of the projection method according to the first embodiment.

FIG. 4 is a flowchart showing the flow of the projection method according to the first embodiment.

FIG. 5 shows projection and capturing of a first reference image.

FIG. 6 shows projection and capturing of a second reference image.

FIG. 7 shows projection and capturing of structured light.

FIG. 8 is a flowchart showing a flow of a projection method according to a second embodiment.

FIG. 9 is a flowchart showing the flow of the projection method according to the second embodiment.

FIG. 10 shows an example of a message in step S170.

FIG. 11 is a flowchart showing a flow of a projection method according to a third embodiment.

FIG. 12 is a flowchart showing the flow of the projection method according to the third embodiment.

FIG. 13 shows an example of a message in step S180.

FIG. 14 is a flowchart showing a flow of a projection method according to a fourth embodiment.

FIG. 15 shows an example of an interface image.

FIG. 16 is a flowchart showing a flow of a projection method according to Modification 1.

### DESCRIPTION OF EMBODIMENTS

As below, preferred embodiments according to the present disclosure will be described with reference to the accompanying drawings. In the drawings, dimensions and scales of the respective parts are different from real ones as appropriate, and some parts are schematically shown in order to facilitate understanding. Further, the scope of the present disclosure is not limited to these embodiments unless particularly described to limit the present disclosure in the following description.

### 1. First Embodiment

### 1-1. Overview of System

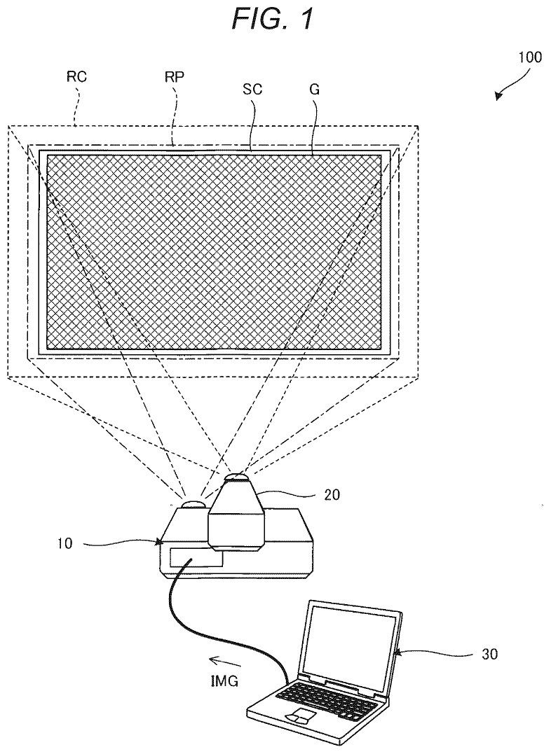

FIG. 1 shows an overview of a system 100 used for a projection method according to a first embodiment. The system 100 is a projection system that projects a projection image G onto a projection target SC.

The projection target SC is formed of, for example, a surface of an object such as a screen. In the example shown in FIG. 1, the outer shape of the projection target SC is a rectangular shape. The outer shape of the projection target SC is not limited to the example shown in FIG. 1, but may be optional. The projection target SC is not limited to a flat surface, but may be, for example, a surface curved in a concave shape or a convex shape.

As shown in FIG. 1, the system 100 includes a projection device 10, a capturing device 20, and a terminal device 30.

The projection device 10 is a display device that projects a projection image G indicated by image data IMG output from the terminal device 30 onto the projection target SC. In the example shown in FIG. 1, the projection image G is projected onto a rectangular area substantially over the entire projection target SC. Further, the projection device 10 can project the projection image G in a region RP including the projection target SC. The region RP is, for example, a region of a wall surface on which the projection target SC is installed. In FIG. 1, the projection image G is shaded. The projection position and the shape of the projection image G with respect to the projection target SC are not limited to the example shown in FIG. 1, but may be optional.

The projection device 10 of the embodiment has a function of controlling the operation of the capturing device 20 and a function of adjusting the shape of the projection image G using the capturing result of t capturing device 20.

The capturing device 20 is a digital camera having a capturing element 21 such as a CCD (Charge Coupled Device) or a CMOS (Complementary Metal Oxide Semiconductor), which will be described later.

The capturing device 20 captures a region RC. The region RC is a region including the projection image G projected on the projection target SC. In the example shown in FIG. 1, the region RC includes the region RP. The capturing device 20 may be a component element of the projection device 10.

The terminal device 30 is a computer having a function of supplying image data IMG to the projection device 10. In the example shown in FIG. 1, the terminal device 30 is a notebook computer. Note that the terminal device 30 is not limited to a notebook computer, but may be, for example, a desktop computer, a smartphone, or a tablet terminal or the like, or may be a video player, a DVD (Digital Versatile Disk) player, a Blu-ray disc player, a hard disk recorder, a television tuner, a set-top box for CATV (Cable television), a video game machine, or the like.

### 1-2. Projection Device

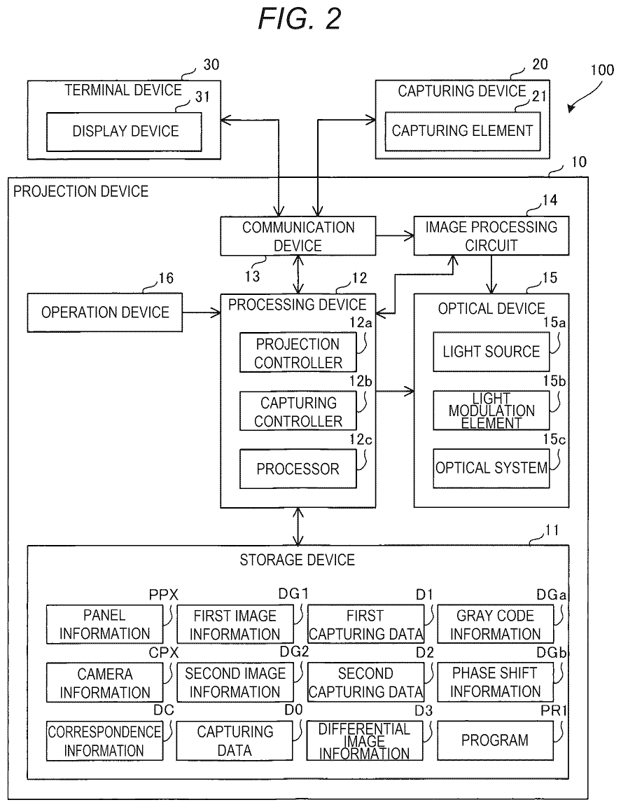

FIG. 2 is a block diagram of the projection device 10 used for the projection method according to the first embodiment. In FIG. 2, in addition to the projection device 10, connection states of the capturing device 20 and the terminal device 30 to the projection device 10 are illustrated. In the example shown in FIG. 2, the terminal device 30 includes a display device 31. The display device 31 is a display device including various display panels such as a liquid crystal display panel and an organic EL display panel.

As shown in FIG. 2, the projection device 10 has a storage device 11, a processing device 12, a communication device 13, an image processing circuit 14, an optical device 15, and an operation device 16. These devices are communicably connected to one another.

The storage device 11 is a storage device that stores a program to be executed by the processing device 12 and data to be processed by the processing device 12. The storage device 11 includes, for example, a hard disk drive or a semiconductor memory. Note that part or all of the storage device 11 may be provided in a storage device, a server, or the like outside the projection device 10.

The storage device 11 stores a program PR1, first image information DG1, second image information DG2, first capturing data D1, second capturing data D2, differential image information D3, gray code information DGa, phase shift information DGb, panel information PPX, camera information CPX, and correspondence information DC.

The program PR1 is a program for execution of a projection method, which will be described later in detail.

The first image information DG1 is information representing a first reference image G1, which will be described later. The first reference image G1 is an image for measurement of contrast of the projection image G, is a uniform image in a bright color such as white, and is projected on the projection target SC by the projection device 10. The first reference image G1 includes a first portion PP1 having a first pixel number PN1. In the embodiment, the first pixel number PN1 is 1280 pixels, and the first portion PP1 is the upper side of the first reference image G1. In the embodiment, the color of the first portion PP1 is white. The color of the first portion PP1 may be one of red, blue, and green, or a combined color obtained by combining two of these colors. The first image information DG1 may be contained in the gray code information DGa or the phase shift information DGb.

The second image information DG2 is information representing a second reference image G2, which will be described later. The second reference image G2 is an image for measurement of contrast of the projection image G, is a uniform image in a dark color such as black, and is projected on the projection target SC by the projection device 10. The second image information DG2 may be contained in the gray code information DGa or the phase shift information DGb.

The first capturing data D1 is information representing a first captured image acquired by capturing of the first reference image G1 projected on the projection target SC by the capturing device 20.

The second capturing data D2 is information representing a second captured image acquired by capturing of the second reference image G2 projected on the projection target SC by the capturing device 20.

The differential image information D3 is information representing a differential image between the first captured image represented by the first capturing data D1 and the second captured image represented by the second capturing data D2.

The gray code information DGa is information representing a plurality of gray code patterns used for measurement in the gray code method as structured light GS, which will be described later.

The phase shift information DGb is information representing a plurality of phase shift patterns used for measurement in the phase shift method as the structured light GS.

In the embodiment, one of a gray code pattern and a phase shift pattern is selectively used as the structured light GS. The type of the structured light GS to be selected is not limited to the gray code pattern and the phase shift pattern, but may be, for example, a binary code pattern, a dot pattern, a rectangular pattern, a polygonal pattern, a checker pattern, or a random dot pattern. The number of types of the structured light GS to be selected is not limited to two, but may be three or more.

Capturing data DO is information representing a captured image acquired by capturing of each of a plurality of structured lights GS sequentially projected onto the projection target SC by the capturing device 20.

The correspondence information DC is information representing a correspondence relationship between coordinates in a display coordinate system of the projection device 10 and coordinates in a capturing coordinate system of the capturing device 20. The display coordinate system of the projection device 10 is a coordinate system with pixels of a light modulation element 15b, which will be described later, as coordinate values. The capturing coordinate system of the capturing device 20 is a coordinate system with pixels of the capturing element of the capturing device 20 as coordinate values.

The panel information PPX is information representing a pixel number of the light modulation element 15b to be described later. The panel information PPX may include information other than the information. The pixel number of the light modulation element 15b may be rephrased as resolution of the light modulation element 15b.

The camera information CPX is information representing a pixel number or resolution of the capturing element 21. The camera information CPX may include information other than the information.

The processing device 12 is a processing device having a function of controlling the respective parts of the projection device 10 and a function of processing various data. For example, the processing device 12 includes a processor such as a CPU (central processing unit). The processing device 12 may be configured with a single processor or may be configured with a plurality of processors. Part or all of the functions of the processing device 12 may be implemented by hardware such as a DSP (Digital Signal Processor), an ASIC (Application Specific Integrated Circuit), a PLD (Programmable Logic Device), or an FPGA (Field Programmable Gate Array). The processing device 12 may be integrated with at least a part of the image processing circuit 14.

The communication device 13 is a communication device that can communicate with various devices, and acquires image data IMG from the terminal device 30 and communicates with the capturing device 20. For example, the communication device 13 is a wired communication device such as a wired LAN (Local Area Network), USB (Universal Serial Bus), or HDMI (High Definition Multimedia Interface) device or a wireless communication device such as an LPWA (Low Power Wide Area), wireless LAN including Wi-Fi, or Bluetooth device. Each of “HDMI”, “Wi-Fi”, and “Bluetooth” is a registered trademark.

The image processing circuit 14 is a circuit that performs necessary processing on the image data IMG from the communication device 13 and inputs the data to the optical device 15. The image processing circuit 14 includes, for example, a frame memory (not illustrated), loads the video data IMG into the frame memory, appropriately executes various kinds of processing such as resolution conversion processing, resizing processing, and distortion correction processing, and inputs the processed data to the optical device 15. Here, the above described correspondence information DC is appropriately used in the various kinds of processing. The image processing circuit 14 may execute processing such as OSD (On Screen Display) processing of generating image information for menu display, operation guidance, or the like, and combining the information with the image data IMG as necessary.

The optical device 15 is a device that projects an image light onto the projection target SC. The optical device 15 has a light source 15a, the light modulation element 15b, and an optical system 15c.

The light source 15a includes, for example, light sources such as halogen lamps, xenon lamps, ultra-high-pressure mercury lamps, LEDs (Light Emitting Diodes), or laser beam sources, and respectively emit red, green, and blue lights. The light modulation element 15b is a light modulator including three light modulation elements provided to correspond to red, green, and blue. Each light modulation element includes, for example, a transmissive liquid crystal panel, a reflective liquid crystal panel, or a DMD (digital mirror device), and modulates the corresponding color light to generate an image light of each color. The image lights of the respective colors generated by the light modulation element 15b are combined by a light combining system into a full-color image light. Further, each light modulation element includes a plurality of pixels for forming the image light of each color. In the embodiment, a pixel number PH of each light modulation element in the horizontal direction is 1280 pixels, and a pixel number PV of each light modulation element in the vertical direction is 1080 pixels. The above described first pixel number PN1 corresponds to the pixel number PH in the embodiment. Accordingly, the panel information PPX includes at least one of first panel information as information indicating the pixel number PH and second panel information as information indicating the pixel number PV. In the embodiment, the panel information PPX may include at least the first panel information. The first reference image G1 of the embodiment is an image light formed using all pixels in the vertical direction and all pixels in the horizontal direction of each light modulation element. The pixel number PH and the pixel number PV of each light modulation element are not particularly limited. The optical system 15c is a projection system including a projection lens that forms and projects an image of the full-color image light from the light modulation element 15b onto the projection target SC.

The operation device 16 is a device that receives an operation from a user. For example, the operation device 16 includes an operation panel and a remote control light receiver, not illustrated. The operation panel is provided on an exterior housing of the projection device 10 and outputs a signal based on an operation from a user. The remote control light receiver receives an infrared signal from a remote controller, not illustrated, decodes the infrared signal, and outputs a signal based on the operation of the remote controller. The operation device 16 is provided according to need and may be omitted.

In the above described projection device 10, the processing device 12 executes the program PR1 stored in the storage device 11, and thereby, functions as a projection controller 12a, a capturing controller 12b, and a processor 12c. Accordingly, the processing device 12 includes the projection controller 12a, the capturing controller 12b, and the processor 12c.

The projection controller 12a controls operations of the image processing circuit 14 and the optical device 15. More specifically, the projection controller 12a controls the operation of the optical device 15 to project the projection image G onto the projection target SC. More specifically, the projection controller 12a projects the first reference image G1, which will be described later, based on the first image information DG1 onto the projection target SC, projects the second reference image G2, which will be described later, based on the second image information DG2 onto the projection target SC, and projects the structured light GS, which will be described later, based on the gray code information DGa or the phase shift information DGb onto the projection target SC.

The capturing controller 12b controls the operation of the capturing device 20. More specifically, the capturing controller 12b acquires the first capturing data D1 by causing the capturing device 20 to capture the first reference image G1 projected onto the projection target SC, acquires the second capturing data D2 by causing the capturing device 20 to capture the second reference image G2 projected onto the projection target SC, or acquires the capturing data DO by causing the capturing device 20 to capture the structured light GS projected onto the projection target SC. Then, the capturing controller 12b stores the acquired capturing data DO, first capturing data D1, and second capturing data D2 in the storage device 11.

The processor 12c generates the correspondence information DC based on the capturing data DO, and appropriately adds processing necessary for generating the correspondence information DC based on the first capturing data D1 and the second capturing data D2.

More specifically, the processor 12c generates the differential image information D3 based on the first capturing data D1 and the second capturing data D2. Further, the processor 12c selects one of the gray code method and the phase shift method based on the differential image information D3. Furthermore, the processor 12c generates the correspondence information DC based on the capturing data DO.

The gray code method is less likely to be affected by unevenness of the projection target SC and ambient light, but required to satisfy the sampling theorem. On the other hand, the phase shift method only requires lower resolution of the capturing device 20, but is easily affected by the unevenness of the projection target SC and the ambient light.

Therefore, one of the gray code method and the phase shift method is selected according to a projection condition. Here, when the projection target SC has unevenness or the projection target SC is irradiated with ambient light, the contrast ratio of the projection image G decreases. When a ratio PN2/PN1 of the second pixel number PN2 as the pixel number of the second portion PC1 corresponding to the first portion PP1 in the first captured image to the first pixel number PN1 is equal to or greater than 2, the sampling theorem is satisfied.

### 1-3. Projection Method

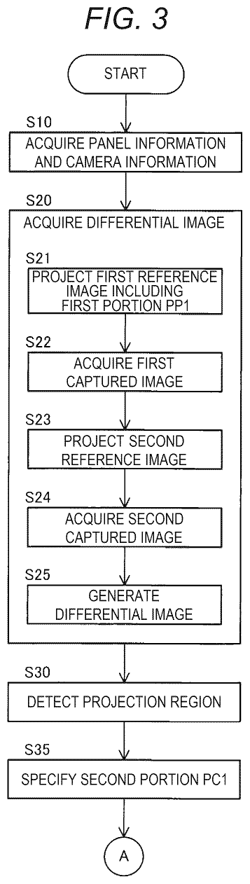

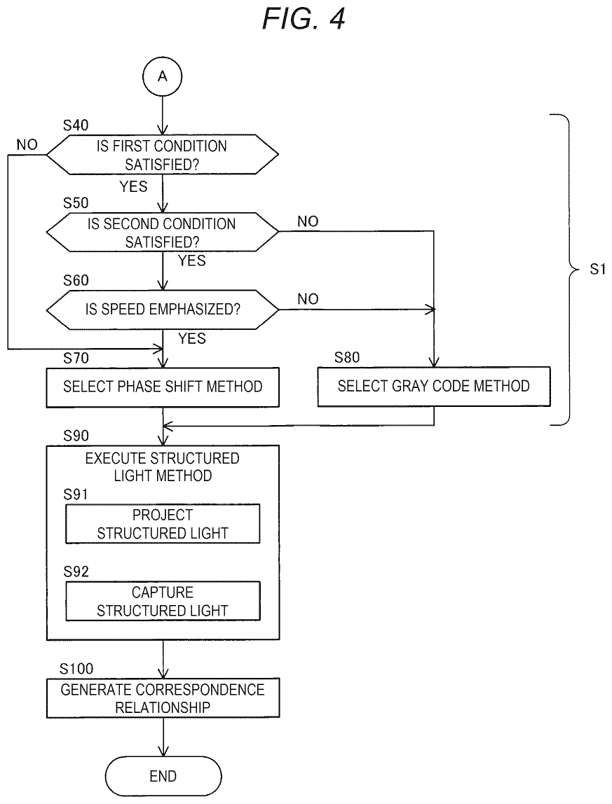

FIGS. 3 and 4 are flowcharts showing a flow of the projection method according to the first embodiment. The projection method is executed by the processing device 12 as an example of “computer” executing the program PR1 using the above described system 100.

The projection method in the projection device 10 includes steps S10 to S100 as shown in FIGS. 3 and 4. As described above, the projection device 10 includes the light modulation element 15b that modulates the light from the light source 15a.

The processing device 12 first executes step S10. In step S10, the panel information PPX and the camera information CPX are acquired. For example, when the panel information PPX and the camera information CPX are stored in the storage device 11 in advance, the acquisition is performed by reading the information. The camera information CPX may be acquired by communication with the capturing device 20. The acquisition of the panel information PPX and the camera information CPX may be performed based on input by a user to an interface image that receives the input of the information. Or, the acquisition of the camera information CPX may be omitted. Step S10 may be executed at any timing before step S40, which will be described later.

After step S10, the processing device 12 executes step S20. In step S20, a differential image represented by the differential image information D3 is acquired. Specifically, step S20 includes steps S21 to S25 in this order. Steps S23 and S24 may be executed before steps S21 and S22.

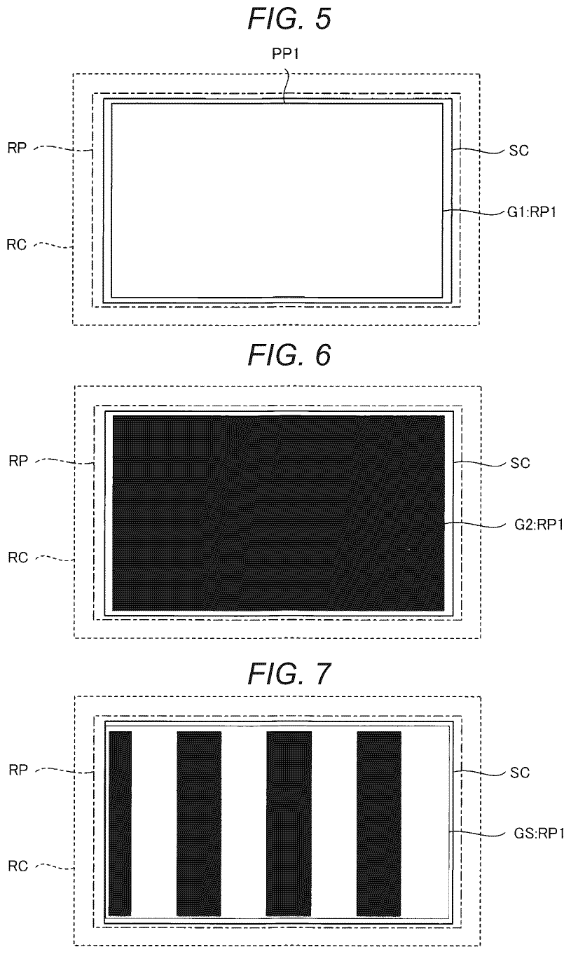

In step S21, the processing device 12 causes the projection device 10 to project the first reference image G1 including the first portion PP1 represented by the first image information DG1 onto the projection target SC. The projection is performed by the projection controller 12a controlling operations of the image processing circuit 14 and the optical device 15 based on the first image information DG1. A specific example of the first reference image G1 will be described later with reference to FIG. 5.

In step S22, the processing device 12 causes the capturing device 20 to capture the first reference image G1 projected on the projection target SC from the projection device 10 and acquires the first captured image. The capturing is performed by the capturing controller 12b controlling the operation of the capturing device 20. By the capturing, the first capturing data D1 representing the first captured image as a capturing result thereof is acquired, and the first capturing data D1 is stored in the storage device 11.

In step S23, the processing device 12 causes the projection device 10 to project the second reference image G2 represented by the second image information DG2 onto the projection target SC. The projection is performed by the projection controller 12a controlling operations of the image processing circuit 14 and the optical device 15 based on the second image information DG2. A specific example of the second reference image G2 will be described later with reference to FIG. 6.

In step S24, the processing device 12 causes the capturing device 20 to capture the second reference image G2 projected on the projection target SC from the projection device 10. The capturing is performed by the capturing controller 12b controlling the operation of the capturing device 20. By the capturing, the second capturing data D2 representing the second captured image as a capturing result thereof is acquired, and the second capturing data D2 is stored in the storage device 11.

In step S25, the processing device 12 generates the differential image information D3 based on the first capturing data D1 and the second capturing data D2. The generation is performed, for example, by calculating a difference between each pixel forming the first captured image represented by the first capturing data D1 and each pixel forming the second captured image represented by the second capturing data D2.

After step S20, the processing device 12 executes step S30. In step S30, the processing device 12 detects a projection region RP1, which will be described later, as a region where the structured light GS is projected in the projection target SC based on one or both of the first capturing data D1 and the second capturing data D2.

After step S30, the processing device 12 executes step S35. In step S35, the processing device 12 analyzes the first capturing data D1 to specify the first portion PP1, that is, the second portion PC1 as a portion corresponding to the upper side of the first reference image G1 in the first captured image. The processing device 12 may detect the second portion PC using a known algorithm such as edge detection, and specify the coordinates of the pixels of the second portion PC in the coordinate system of the first captured image. Step S35 may be executed at any timing after step S22 and before step S40 to be described later.

After step S30, the processing device 12 executes step S1. In step S1, the type of the structured light GS to be projected from the projection device 10 is determined based on the differential image represented by the differential image information D3, the first pixel number PN1 of the first portion PP1 of the first reference image G1, and the second pixel number PN2 as the pixel number of the second portion PC1 corresponding to the first portion PP1 in the first captured image. Specifically, step S1 includes steps S40 to S80. In the embodiment, the first pixel number PN1 is equal to the pixel number PH indicated by the first panel information contained in the panel information PPX.

In step S40, the processing device 12 determines whether the ratio PN2/PN1 of the second pixel number PN2 as the pixel number of the second portion PC1 corresponding to the first portion PP1 in the first captured image to the first pixel number PN1 of the first portion PP1 satisfies a first condition. The first condition is, for example, a condition that the sampling theorem is satisfied, and specifically, the ratio (PN2/PN1) of the second pixel number PN2 to the first pixel number PN1 is 2 or more. That is, the first condition is that, in the coordinate system of the first captured image, one pixel of the first reference image G1 is observed in two pixels (two elements) of the capturing element 21. For example, in step S40, the processing device 12 determines whether the second portion PC1 corresponding to the first portion PP1 having 1920 pixels has 3840 pixels or more in the coordinate system of the first captured image.

When the first condition is satisfied (step S40: YES), in step S50, the processing device 12 determines whether the gray level value of the differential image represented by the differential image information D3 satisfies a second condition. The second condition is, for example, a condition that the contrast ratio is equal to or greater than a predetermined threshold value, and specifically, the second condition is that an average value of all pixel gray level values forming the differential image represented by the differential image information D3 is equal to or greater than a predetermined threshold value. When the average value is less than the predetermined threshold value, the processing device 12 can determine that the differential image has many darker portions.

When the second condition is satisfied (step S50: YES), in step S60, the processing device 12 determines whether to emphasize the speed of the structured light method. The determination is made based on, for example, a setting of a mode related to generation of the correspondence information DC. The setting of the mode is made by receiving input from the user with respect to an interface image (not shown) or the like. The interface image has, for example, a button for selecting whether to emphasize the speed, or a button for determining to prioritize the use of a specific structured light method (in the embodiment, one of the gray code method and the phase shift method). The display of the interface image may be executed in step S60 or may be executed before step S60.

As described above, in step S60, the processing device 12 receives the setting of the mode related to the generation of the correspondence relationship between the pixels of the light modulation element 15b and the pixels of the capturing element 21 based on the structured light from the user, and determines the type of the structured light to be projected from the projection device 10 according to the setting when the first condition is satisfied (step S40: YES) and the second condition is satisfied (step S50: YES).

Here, the mode is one of a first mode in which the number of structured lights is M (M is a natural number of 2 or more) and a second mode in which the number of structured lights is N (N is a natural number more than M). When the setting is a first setting corresponding to a first mode, the processing device 12 emphasizes the speed (step S60: YES). On the other hand, when the setting is a second setting corresponding to a second mode, the device does not emphasize the speed (step S60: NO).

When the first condition is not satisfied (step S40: NO) or when the speed of the structured light method is emphasized (step S60: YES), the processing device 12 selects the phase shift method as the type of the structured light to be projected from the projection device 10 in step S70. As described above, in step S70, when the ratio PN2/PN1 does not satisfy the first condition (step S40: NO) and the gray level value of the differential image represented by the differential image information D3 satisfies the second condition (step S50: YES), the device determines that the type of the structured light to be projected from the projection device 10 is the phase shift pattern. When the setting is the first setting corresponding to the first mode, the processing device 12 emphasizes the speed (step S60: YES), and determines that the type of the structured light to be projected from the projection device 10 is the phase shift pattern in step S70.

On the other hand, when the second condition is not satisfied (step S50: NO) or when the speed of the structured light method is not emphasized (step S60: NO), the processing device 12 selects the gray code method as the type of the structured light to be projected from the projection device 10 in step S80. As described above, in step S80, when the ratio PN2/PN1 satisfies the first condition (step S40: YES) and the gray level value of the differential image represented by the differential image information D3 does not satisfy the second condition (step S50: NO), the device determines that the type of the structured light to be projected from the projection device 10 is the gray code pattern. When the setting is the second setting corresponding to the second mode, the speed is not emphasized (step S60: NO), and the device determines that the type of the structured light to be projected from the projection device 10 is the gray code pattern in step S80.

After step S70 or step S80, the processing device 12 executes step S90. In step S90, the plurality of pieces of capturing data DO are acquired by capturing of each of a plurality of structured lights GS projected from the projection device 10 onto the projection target SC by the capturing device 20 according to the structured light method selected in step S70 or step S80. Specifically, step S90 includes step S91 and step S92.

In step S91, the projection device 10 sequentially projects the plurality of structured lights GS, which will be described later, onto the projection target SC according to the result of the determination of the type of the structured light. The projection is performed by the projection controller 12a controlling the operations of the image processing circuit 14 and the optical device 15 based on the gray code information DGa or the phase shift information DGb.

In step S92, each of a plurality of structured lights GS to be described later projected from the projection device 10 onto the projection target SC is captured by the capturing device 20. The capturing is performed by the capturing controller 12b controlling the operation of the capturing device 20. By the capturing, the capturing data DO is generated, and the generated capturing data DO is stored in the storage device 11.

After step S90, the processing device 12 executes step S100. In step S100, the coordinates in the display coordinate system of the projection device 10 are correlated to the coordinates in the capturing coordinate system of the capturing device 20 based on the capturing data DO. The correlation is performed by the processor 12c using a known structured light method based on the capturing data DO. Correspondence information DC is generated by the correlation, and the generated correspondence information DC is stored in the storage device 11.

FIG. 5 shows projection and capturing of the first reference image G1. In step S21, as shown in FIG. 5, the first reference image G1 represented by the first image information DG1 is projected on the projection target SC from the projection device 10. In the example shown in FIG. 5, the first reference image G1 is a uniform white image. In FIG. 5, the outer edge of the first reference image G1 is located inside the outer edge of the region RP, but the outer edge of the first reference image G1 may coincide with the outer edge of the region RP.

In step S22, the first reference image G1 is captured by the capturing device 20 in the region RC including the first reference image G1 projected on the projection target SC.

FIG. 6 shows projection and capturing of the second reference image G2. In step S23, as shown in FIG. 6, the second reference image G2 represented by the second image information DG2 is projected on the projection target SC from the projection device 10. In the example shown in FIG. 6, the second reference image G2 is a uniform black image. In FIG. 6, the outer edge of the second reference image G2 is located inside the outer edge of the region RP, but the outer edge of the second reference image G2 may coincide with the outer edge of the region RP. However, the outer edge of the second reference image G2 preferably coincides with the outer edge of the first reference image G1.

In step S24, the second reference image G2 is captured by the capturing device 20 in the region RC including the second reference image G2 projected on the projection target SC.

In step S25, a differential image between the above described first reference image G1 and second reference image G2 is generated. In step S30, the projection region RP1 is detected by edge detection of the first reference image G1 or the second reference image G2 based on the first capturing data D1 and the second capturing data D2. Therefore, the range in which the first reference image G1 or the second reference image G2 is projected is determined as the projection region RP1.

When the ratio PN2/PN1 is equal to or more than 2, that is, when the first condition is satisfied, the sampling theorem is satisfied, and thus the phase shift method is selected.

Further, when the gray level value of the differential image between the first reference image G1 and the second reference image G2 is equal to or greater than the predetermined threshold value, that is, when the second condition is satisfied, a determination that the projection target SC does not have unevenness and the projection target SC is not irradiated with the ambient light can be made. Therefore, in this case (step S50: YES), the phase shift method can be selected. On the other hand, when the gray level value of the differential image is less than the predetermined threshold value, a determination that the projection target SC has unevenness or the projection target SC is irradiated with the ambient light can be made. Therefore, in this case (step S50: NO), the gray code method is selected.

FIG. 7 shows projection and capturing of the structured light GS. FIG. 7 shows the structured light GS when the gray code method is selected.

In step S91, as shown in FIG. 7, the structured light GS selected in step S70 or step S80 is projected from the projection device 10 onto the projection target SC. In the example illustrated in FIG. 7, the structured light GS is a gray code pattern. In FIG. 7, the outer edge of the structured light GS is located inside the outer edge of the region RP, but the outer edge of the structured light GS may coincide with the outer edge of the region RP. However, the outer edge of the structured light GS preferably coincides with the outer edges of the first reference image G1 and the second reference image G2.

In step S92, the capturing device 20 captures the structured light GS in the region RC including the structured light GS projected onto the projection target SC.

Although not illustrated, the above described steps S91 and S92 are repeatedly executed for the number of structured lights DS. Thereby, the capturing data DO is obtained. Then, in step S100, the correspondence information DC is generated based on the capturing data DO.

As described above, the projection method according to the embodiment includes steps S21, S22, S23, S24, S1, and S91. Accordingly, since the structured light to be projected from the projection device 10 is automatically determined by the processing device 12, the convenience for the user can be increased.

In the embodiment, as described above, the processing device 12 executes step S40, step S50, step S70, and step S80. Accordingly, when the ratio PN2/PN1 satisfies the first condition (step S40: YES) and the gray level value does not satisfy the second condition (step S50: NO), a determination that the type of the structured light to be projected from the projection device 10 is the gray code pattern is made. When the ratio PN2/PN1 does not satisfy the first condition (step S40: NO) and the gray level value of the differential image indicated by the differential image information D3 satisfies the second condition, a determination that the type of the structured light to be projected from the projection device 10 is the phase shift pattern is made. As described above, an appropriate type of the structured light with higher accuracy of the gray code pattern and the phase shift pattern can be determined according to the projection condition.

Further, as described above, the processing device 12 executes step S60. In step S60, the setting of the mode related to the generation of the correspondence relationship between the pixels of the light modulation element 15b and the pixels of the capturing element 21 based on the structured light is received from the user, and when the ratio PN2/PN1 satisfies the first condition (step S40: YES) and the gray level value of the differential image represented by the differential image information D3 satisfies the second condition (step S50: YES), the type of the structured light to be projected from the projection device 10 is determined according to the setting. Accordingly, when the measurement accuracy necessary for both the gray code pattern and the phase shift pattern can be secured, the type of the structured light can be determined according to the user's wish.

Further, as described above, the mode is one of the first mode in which the number of structured lights is M (M is a natural number of 2 or more) and the second mode in which the number of structured lights is N (N is a natural number more than M). When the setting is the first setting corresponding to the first mode (step S60: YES), the processing device 12 determines that the type of the structured light to be projected from the projection device 10 is the phase shift pattern, and when the setting is the second setting corresponding to the second mode (step S60: NO), determines that the type of the structured light to be projected from the projection device 10 is the gray code pattern. In the above described configuration, when the measurement accuracy necessary for both the gray code pattern and the phase shift pattern can be secured, the type of the structured light can be determined according to the user's wish.

### 2. Second Embodiment

As below, a second embodiment of the present disclosure will be described. In the embodiment exemplified as below, elements having effects and functions similar to those in the first embodiment are denoted by the same reference numerals used in the first embodiment, and the detailed description thereof will be omitted as appropriate.

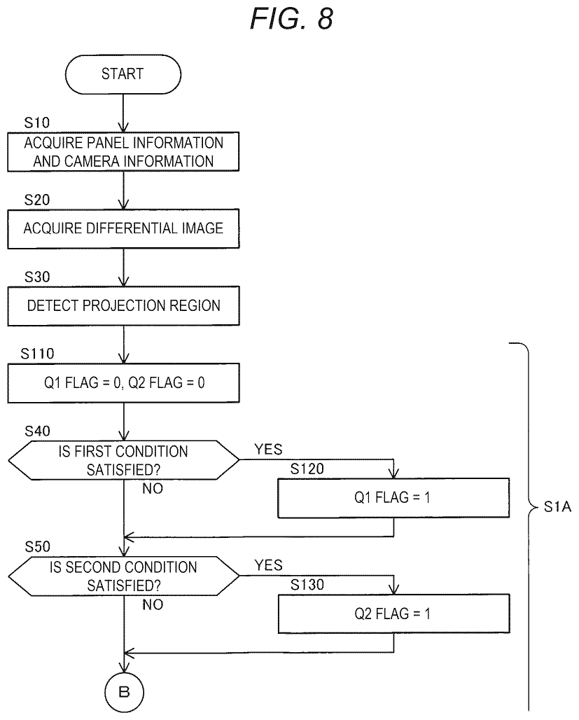

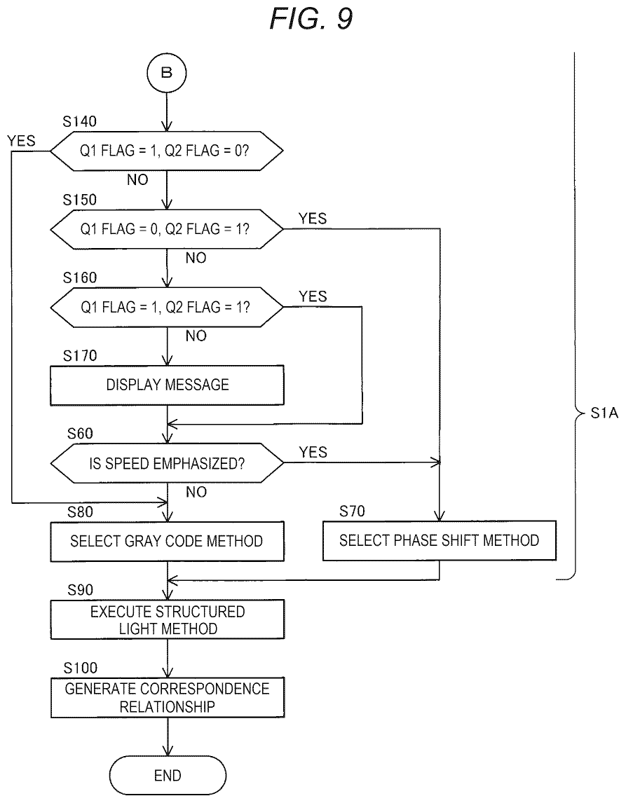

FIGS. 8 and 9 are flowcharts showing a flow of a projection method according to the second embodiment. The projection method is the same as the projection method of the first embodiment except that step S1A is provided instead of step S1. Step S1A is the same as step S1 of the first embodiment except that steps S110 to S170 are added.

In step S1A, after step S30, the processing device 12 sets each of a Q1 flag and a Q2 flag to 0 in step S110, and then executes step S40.

When the first condition is satisfied (step S40: YES), the processing device 12 sets the Q1 flag to 1 and then proceeds to step S50, whereas when the first condition is not satisfied (step S40: NO), directly proceeds to step S50.

When the second condition is satisfied (step S50: YES), the processing device 12 sets the Q2 flag to 1 and then proceeds to step S140, whereas when the second condition is not satisfied (step S50: NO), directly proceeds to step S140.

In step S140, the processing device 12 determines whether a condition that the Q1 flag is 1 and the Q2 flag is 0 is satisfied. The condition is that the first condition is satisfied and the second condition is not satisfied. Accordingly, when the condition that the Q1 flag is 1 and the Q2 flag is 0 is satisfied (step S140: YES), the processing device 12 executes step S80 like the first embodiment.

When the condition that the Q1 flag is 1 and the Q2 flag is 0 is not satisfied (step S140: NO), the processing device 12 determines whether a condition that the Q1 flag is 0 and the Q2 flag is 1 is satisfied in step S150. The condition is that the first condition is not satisfied and the second condition is satisfied. Therefore, when the condition that the Q1 flag is 0 and the Q2 flag is 1 is satisfied (step S150: YES), the processing device 12 executes step S70 like the first embodiment.

When the condition that the Q1 flag is 0 and the Q2 flag is 1 is not satisfied (step S140: NO), the processing device 12 determines whether a condition that the Q1 flag is 1 and the Q2 flag is 1 is satisfied in step S160. The condition is that the first condition is satisfied and the second condition is satisfied. Accordingly, when the condition that the Q1 flag is 1 and the Q2 flag is 1 is satisfied (step S160: YES), the processing device 12 executes step S60 like the first embodiment.

When the condition that the Q1 flag is 1 and the Q2 flag is 1 is not satisfied (step S160: NO), the processing device 12 executes step S170, and then, proceeds to step S60. In step S170, the projection device 10 projects a message Ra, which will be described later.

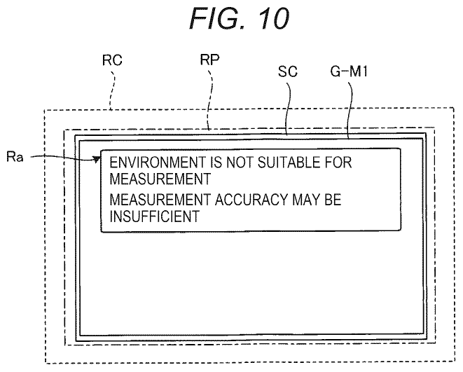

FIG. 10 shows an example of the message Ra in step S170. In step S170, an image G-M1 is projected on the projection target SC from the projection device 10.

The image G-M1 is a projection image G containing the message Ra. The message Ra indicates that the accuracy of the generation of correspondence relationship between the pixels of the light modulation element 15b and the pixels of the capturing element 21 based on the structured light GS becomes lower. In the example shown in FIG. 10, as the message Ra, “ENVIRONMENT IS NOT SUITABLE FOR MEASUREMENT. MEASUREMENT ACCURACY MAY BE INSUFFICIENT” is displayed. The message Ra is not limited to the example shown in FIG. 10, but may be any indication as long as the indication indicates that the accuracy of generation of the correspondence relationship becomes lower.

According to the above described second embodiment, the convenience for the user can be increased. In the embodiment, as described above, when the ratio PN2/PN1 does not satisfy the first condition and the gray level value of the differential image represented by the differential image information D3 does not satisfy the second condition, the processing device 12 causes the projection device 10 to project the message Ra indicating that the accuracy of generation of the correspondence relationship between the pixels of the light modulation element 15b and the pixels of the capturing element 21 based on the structured light becomes lower. As a result, when the necessary measurement accuracy for both the gray code pattern and the phase shift pattern is not secured, the user can be informed of that.

### 3. Third Embodiment

As below, a third embodiment of the present disclosure will be described. In the embodiment exemplified as below, elements having effects and functions similar to those in the first embodiment are denoted by the same reference numerals used in the first embodiment, and the detailed description thereof will be omitted as appropriate.

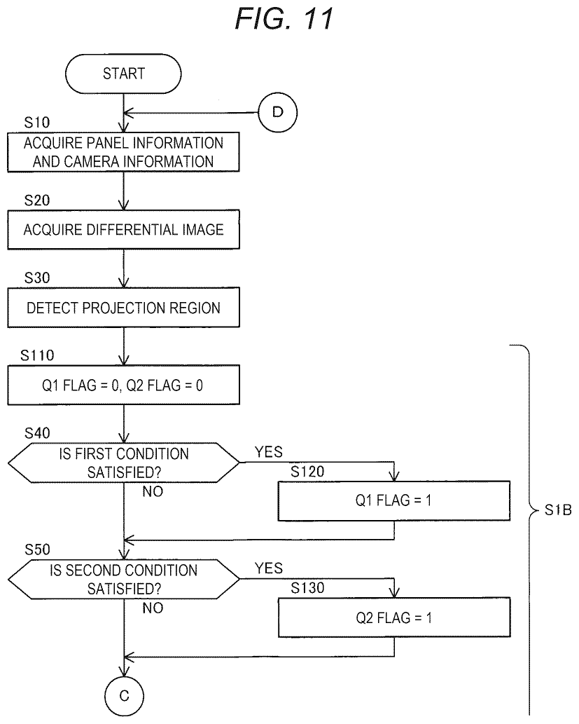

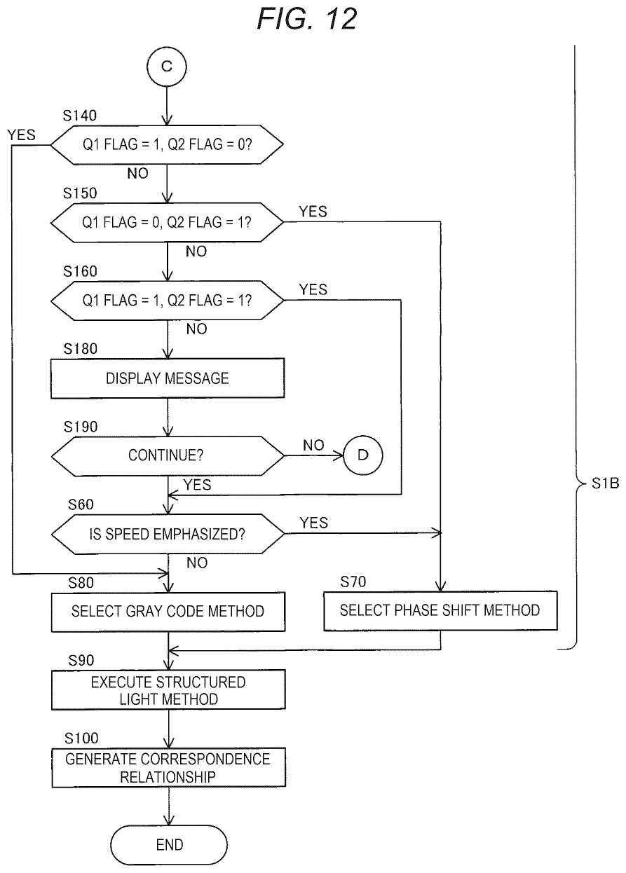

FIGS. 11 and 12 are flowcharts showing a flow of a projection method according to the third embodiment. The projection method is the same as the projection method of the first embodiment except that step S1B is provided instead of step S1. Step S1B is the same as step S1 of the first embodiment except that steps S110 to S160 and steps S180 and S190 are added. That is, step S1B is the same as step S1A of the second embodiment except that step S180 is provided instead of step S170 and step S190 is added.

In step S1B, when a condition that the Q1 flag is 1 and the Q2 flag is 1 is not satisfied (step S160: NO), the processing device 12 causes the projection device 10 to project an image G-M2, which will be described later, in step S180. The image G-M2 contains a message Rb, which will be described later, in addition to the above described message Ra, and can receive a selection as to whether to continue the processing.

After step S180, the processing device 12 determines whether to continue the processing in step S190. This determination is made based on the selection result in step S180.

When the processing is continued (step S190: YES), the processing device 12 proceeds to step S80. Thereby, as in the second embodiment, the gray code method is executed after the user is notified that the necessary measurement accuracy is not secured in both the gray code pattern and the phase shift pattern. On the other hand, when the processing is not continued (step S190: NO), the processing device 12 returns to step S10. Thereby, the measurement can be performed again after the projection condition is improved.

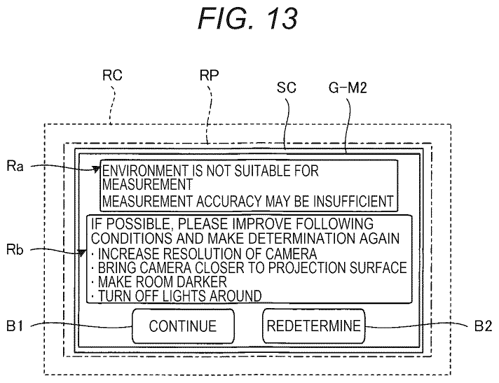

FIG. 13 shows an example of the message in step S180. In step S180, the image G-M2 is projected on the projection target SC from the projection device 10.

The image G-M2 is the projection image G containing the message Rb and buttons B1 and B2 in addition to the message Ra of the second embodiment.

The message Rb includes candidates for solutions for improving the accuracy. In the example illustrated in FIG. 13, as the message Rb, the phrase “IF POSSIBLE, PLEASE IMPROVE FOLLOWING CONDITIONS AND MAKE DETERMINATION AGAIN” is displayed together with the phrases “INCREASE RESOLUTION OF CAMERA”, “BRING CAMERA CLOSER TO PROJECTION SURFACE”, “MAKE ROOM DARKER”, AND “TURN OFF LIGHTS AROUND” indicating the candidates for measures for improvement. The message Rb is not limited to the example illustrated in FIG. 13 and may be any indication as long as the indication includes candidates for solutions for improving accuracy.

The button B1 is a button for continuing the processing without change. When the button B1 is operated, a determination that the processing is continued is made in step S190 (step S190: YES). The button B2 is a button for redoing the processing. When the button B2 is operated, a determination that the processing is not continued is made in step S190 (step S190: NO).

According to the above described third embodiment, the convenience for the user can be increased. In the embodiment, as described above, the message Rb contains the candidates for solutions for improving the accuracy. Thereby, the necessary measurement accuracy for both the gray code pattern and the phase shift pattern is not secured, the user can be informed of the solution therefor.

### 4. Fourth Embodiment

As below, a fourth embodiment of the present disclosure will be described. In the embodiment exemplified as below, elements having effects and functions similar to those in the first embodiment are denoted by the same reference numerals used in the first embodiment, and the detailed description thereof will be omitted as appropriate.

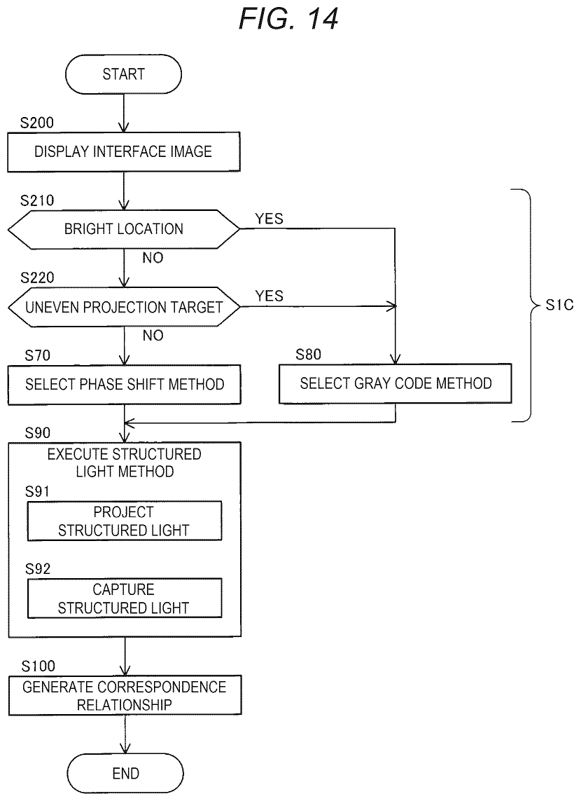

FIG. 14 is a flowchart showing a flow of a projection method according to the fourth embodiment. The projection method is the same as the projection method of the first embodiment except that step S200 is provided instead of steps S10 to S30 and step S1C is provided instead of step S1. Step S1C is the same as step S1 of the first embodiment except that steps S210 and S220 are provided instead of steps S40 to S60.

In the projection method of the embodiment, first, in step S200, the processing device 12 causes the projection device 10 to project an interface image G-M3, which will be described later. The interface image G-M3 can receive input of information on projection conditions such as brightness of the installation location of the projection target SC and presence or absence of unevenness.

After step S200, in step S210, the processing device 12 determines whether the installation location of the projection target SC is a bright location.

When the installation location of the projection target SC is not a bright location (step S210: NO), the processing device 12 determines whether the projection target SC has unevenness in step S220.

When the projection target SC does not have unevenness (step S220: NO), the processing device 12 executes step S70. Therefore, when the installation location of the projection target SC is not a bright location (step S210: NO) and the projection target SC does not have unevenness (step S220: NO), the phase shift method is selected.

On the other hand, when the installation location of the projection target SC is a bright location (step S210: YES), or when the projection target SC has unevenness (step S220: YES), the processing device 12 executes step S80. Therefore, when the installation location of the projection target SC is a bright location (step S210: YES), or when the projection target SC has unevenness (step S220: YES), the phase shift method is selected.

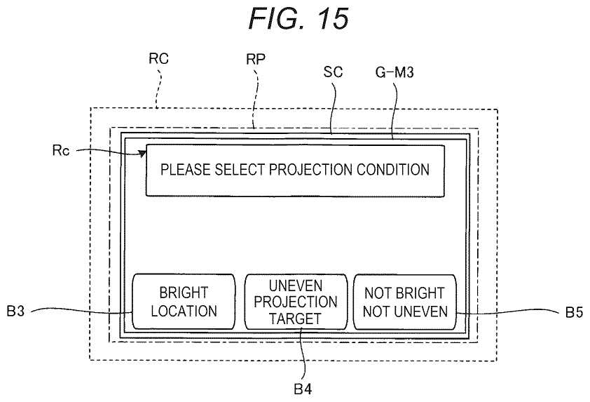

FIG. 15 shows an example of the interface image G-M3. The interface image G-M3 is a projection image G for receiving input of the information on the projection condition. The interface image G-M3 contains a message Rc and buttons B3, B4, and B5.

The message Rc is an indication prompting input of information on the projection condition. In the example shown in FIG. 15, as the message Rc, a phrase “SELECT PROJECTION CONDITION” is displayed. The message Rc is not limited to the example illustrated in FIG. 15 and may be any indication as long as the indication prompts input of the information on the projection condition. The message Rc may be displayed as necessary or may be omitted.

The button B3 is a button for setting that the installation location of the projection target SC is a bright location as the projection condition. The button B4 is a button for setting that the projection target SC has unevenness as the projection condition. The button B5 is a button for setting that the installation location of the projection target SC is not a bright location and the projection target SC does not have unevenness as the projection condition. The information on the projection condition input in the interface image G-M3 is not limited to the example shown in FIG. 15, but may be any information on the first condition, the second condition, and the like in the first above described embodiment.

The above described buttons B3, B4, and B5 can alternatively receive an operation from the user. When the button B3 is operated, in step S210, a determination that the installation location of the projection target SC is a bright location is made (step S210: YES). Thereby, the gray code method is selected as described above. When the button B4 is operated, a determination that the projection target SC has unevenness is made (step S220: YES). Thereby, the gray code method is selected as described above. When the button B5 is operated, in step S210, a determination that the installation location of the projection target SC is not a bright location is made (step S210: NO), and in step S220, a determination that the projection target SC does not have unevenness is made (step S220: NO). Thereby, the phase shift method is selected as described above.

According to the above described fourth embodiment, the convenience for the user can be increased. As described above, the projection method of the embodiment includes step S200, step S1C, and step S91. In step S200, the interface image G-M3 for receiving the input of the information on the projection condition is displayed. In step S1C, the processing device 12 determines the type of the structured light to be projected from the projection device 10 based on the projection condition input using the interface image G-M3. In step S91, the projection device 10 projects the structured light GS according to the result of the determination of the type. As described above, since an appropriate type of the structured light GS is selected by the user inputting the projection condition, the convenience for the user can be increased.

### 5. Modified Examples

The respective embodiments exemplified as above can be variously modified. Specific configurations of modifications applicable to the above described embodiments will be exemplified as below. Two or more configurations optionally selected from the following exemplifications can be combined as appropriate as long as the configurations are mutually consistent.

### 5-1. Modification Example 1

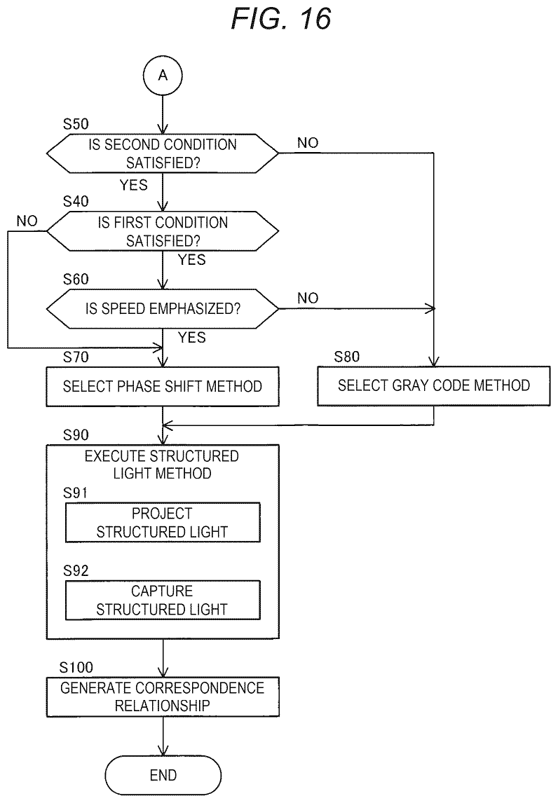

FIG. 16 is a flowchart showing a flow of a projection method according to Modification Example 1. The projection method is the same as the projection method of the first embodiment except that the execution order of step S40 and step S50 is reversed. According to Modification Example 1 described above, the convenience for the user can be increased.

### 5-2. Modification Example 2

In the above described embodiments, the configuration in which the processing device 12 of the projection device 10 executes the program PR1 is exemplified, however, the present disclosure is not limited to the configuration. For example, a processing device as a computer communicably connected to the projection device 10 and the capturing device 20 may execute the program PR1.

### 5-3. Modification Example 3

In the above described embodiments, the configuration in which the first pixel number PN1 is the pixel number of the first portion PP1 as the upper side of the first reference image G1 is exemplified, however, the present disclosure is not limited to the configuration. For example, the pixel number may be a pixel number of any portion of the first reference image G1 such as the lower side, the left side, or the right side of the first reference image G1 or the center of the first reference image G1. As long as the processing device 12 recognizes the pixel number of any portion of the first reference image G1, the portion serving as the reference of the first pixel number is not particularly limited. The first pixel number PN1 may be smaller than 1280 pixels. Or, the first reference image G1 may be an image light formed using part of pixels in the vertical direction and part of pixels in the horizontal direction of each light modulation element. The first pixel number PN1 may be the pixel number PV or may be the pixel number smaller than the pixel number PV.

### 5-4. Modification Example 4

In the above described embodiments, the configuration in which the processing device 12 determines whether the ratio PN2/PN1 is 2 or more using the first pixel number PN1 as the pixel number of the first portion PP1 of the first reference image G1 is exemplified, however, the present disclosure is not limited to the configuration. For example, the pixel number of a first portion PP1′ of an image different from the first reference image G1 may be used as the first pixel number PN1. That is, in the above described embodiment, the first reference image G1 is used for both the detection of the projection region RP1 and the calculation of the ratio PN2/PN1, however, for example, the first reference image G1 may be used for detection of the projection region RP1 and an image different from the first reference image G1 may be separately projected for calculation of the ratio PN2/PN1. An image different from the first reference image G1 for calculation of the ratio PN2/PN1 may be projected at any timing before step S40.

### 5-5. Modification Example 5

In the above described embodiments, the configuration in which the correspondence information DC is used for adjustment of the projection image G is exemplified, however, the present disclosure is not limited to the configuration. For example, the correspondence information DC may be used for display of a pattern of a lattice shape or the like having uniformity on the projection target SC, or may be used for, with a three-dimensional shape model of the projection target SC as seen from the capturing device 20 reflected on three-dimensional image editing software or the like, drawing a picture on the model, causing a PC monitor or the like to display how the picture is seen from the projection device 10, and causing the projection device 10 to project the picture.

### 6. Appendixes

As below, the summary of the present disclosure will be appended.

(Appendix 1) A first configuration as a preferred example of a projection method of the present disclosure is a projection method in a projection device including a light modulation element modulating a light from a light source, including projecting a first reference image including a first portion having a first pixel number onto a projection target, acquiring a first captured image by capturing the first reference image by a capturing device having a capturing element, projecting a second reference image onto the projection target, acquiring a second captured image by capturing the second reference image by the capturing device, determining a type of a structured light to be projected from the projection device based on a differential image between the first captured image and the second captured image, the first pixel number, and a second pixel number as a pixel number of a second portion corresponding to the first portion in the first captured image by a processing device, and projecting the structured light from the projection device according to a result of the determination of the type of the structured light.

In the above described configuration, since the structured light to be projected from the projection device is automatically determined by the processing device, the convenience for the user can be increased.

(Appendix 2) A second configuration as a preferred example of a projection method of the present disclosure is a projection method in a projection device including a light modulation element modulating a light from a light source, including displaying an interface image for receiving input of information on a projection condition, determining a type of a structured light to be projected from the projection device based on a projection condition input using the interface image by a processing device, and projecting the structured light from the projection device according to a result of the determination of the type.

In the above described configuration, since an appropriate type of the structured light is selected by the user inputting the projection condition, the convenience for the user can be increased.

(Appendix 3) In a third configuration as a preferred example of the first configuration, the processing device executes determining whether a ratio of the second pixel number to the first pixel number satisfies a first condition, determining whether a gray level value of the differential image satisfies a second condition, determining that the type of the structured light to be projected from the projection device is a gray code pattern when the ratio satisfies the first condition and the gray level value does not satisfy the second condition, and determining that the type of the structured light to be projected from the projection device is a phase shift pattern when the ratio does not satisfy the first condition and the gray level value satisfies the second condition. In the above described configuration, an appropriate type of the structured light with higher accuracy of the gray code pattern and the phase shift pattern can be determined according to the projection condition.

(Appendix 4) In a fourth configuration as a preferred example of the third configuration, the processing device receives a setting of a mode related to generation of a correspondence relationship between a pixel of the light modulation element and a pixel of the capturing element based on the structured light from a user, and determines the type of the structured light to be projected from the projection device according to the setting when the ratio satisfies the first condition and the gray level value satisfies the second condition. In the above described configuration, when the measurement accuracy necessary for both the gray code pattern and the phase shift pattern can be secured, the type of the structured light can be determined according to the user's wish.

(Appendix 5) In a fifth configuration as a preferred example of the fourth configuration, the mode is one of a first mode in which a number of the structured lights is M, M being a natural number of 2 or more and a second mode in which the number of the structured lights is N, N being a natural number more than M, and the processing device determines that the type of the structured light to be projected from the projection device is a phase shift pattern when the setting is a first setting corresponding to the first mode, and determines that the type of the structured light to be projected from the projection device is a gray code pattern when the setting is a second setting corresponding to the second mode. In the above described configuration, when the measurement accuracy necessary for both the gray code pattern and the phase shift pattern can be secured, the type of the structured light can be determined according to the user's wish.

(Appendix 6) In a sixth configuration as a preferred example of the third configuration, the processing device causes the projection device to project a message indicating that accuracy of generation of the correspondence relationship between the pixel of the light modulation element and the pixel of the capturing element based on the structured light becomes lower when the ratio does not satisfy the first condition and the gray level value does not satisfy the second condition. In the above described configuration, when the necessary measurement accuracy for both the gray code pattern and the phase shift pattern is not secured, the user can be informed of that.

(Appendix 7) In a seventh configuration as a preferred example of the sixth configuration, the message includes a candidate for a solution for increasing the accuracy. In the above described configuration, the necessary measurement accuracy for both the gray code pattern and the phase shift pattern is not secured, the user can be informed of the solution therefor.

What is claimed is:

1. A projection method comprising:
projecting a first reference image including a first portion having a first pixel number from a projection device onto a projection target;
acquiring a first captured image by capturing the first reference image by a capturing device;
projecting a second reference image onto the projection target;
acquiring a second captured image by capturing the second reference image by the capturing device;
determining a type of a structured light to be projected from the projection device based on a differential image between the first captured image and the second captured image, the first pixel number, and a second pixel number as a pixel number of a second portion corresponding to the first portion in the first captured image by a processing device; and
projecting the structured light from the projection device according to the type.

2. A projection method comprising:
displaying an interface image for receiving input of information on a projection condition;
determining a type of a structured light to be projected from a projection device based on a projection condition input using the interface image by a processing device; and
projecting the structured light from the projection device according to the type.

3. The projection method according to claim 1, wherein
the processing device executes
determining whether a ratio of the second pixel number to the first pixel number satisfies a first condition,
determining whether a gray level value of the differential image satisfies a second condition,
determining that the type is a gray code pattern when the ratio satisfies the first condition and the gray level value does not satisfy the second condition, and
determining that the type is a phase shift pattern when the ratio does not satisfy the first condition and the gray level value satisfies the second condition.

4. The projection method according to claim 3, wherein
the processing device receives a setting of a mode related to generation of a correspondence relationship between a pixel of a light modulation element and a pixel of a capturing element based on the structured light from a user, and determines the type according to the setting when the ratio satisfies the first condition and the gray level value satisfies the second condition.

5. The projection method according to claim 4, wherein
the mode is one of a first mode in which a number of the structured lights is M, M being a natural number of 2 or more and a second mode in which the number of the structured lights is N, N being a natural number more than M, and
the processing device determines that the type is a phase shift pattern when the setting is a first setting corresponding to the first mode, and determines that the type is a gray code pattern when the setting is a second setting corresponding to the second mode.

6. The projection method according to claim 3, wherein
the processing device causes the projection device to project a message indicating that accuracy of generation of a correspondence relationship between a pixel of a light modulation element and a pixel of a capturing element based on the structured light becomes lower when the ratio does not satisfy the first condition and the gray level value does not satisfy the second condition.

7. The projection method according to claim 6, wherein
the message includes a candidate for a solution for increasing the accuracy.
